(19) United States
(12) Patent Application Publication
(10) Pub. No.: US 2004/0253994 A1
(43) Pub. Date: Dec. 16, 2004

(54) Call signal volume- and/or hands-free function-controlled mobile radio device

(76) Inventors: Josef Lampl, Schongeising (DE); Annette Seiter, Munchen (DE)

Correspondence Address: BELL, BOYD & LLOYD, LLC, P. O. BOX 1135, CHICAGO, IL, 60690-1135, US

(21) Appl. No.: 10/488,064

(22) PCT Filed: Aug. 26, 2002
(86) PCT No.: PCT/DE02/03128

(30) Foreign Application Priority Data
Aug. 27, 2001 (DE) 101 41 798.5
Nov. 22, 2001 (DE) 101 572 17.5

(51) Int. Cl. H04M 1/00

(52) U.S. Cl. 455/569.1

(57) ABSTRACT

A mobile radio device is disclosed that includes a microphone and a loudspeaker, wherein said loudspeaker (LP) is adapted for sound reproduction in the hands-free mode and/or for call signaling. The device is provided with a unit to acoustically measure the distance between the loudspeaker and an obstacle, the distance measured by measuring the propagation time of the test sound. The call signal volume or hands-free volume is controlled in accordance with the propagation time measured. Additionally, the output volume on the loudspeaker can be controlled in accordance with the measured volume of the reflected test sound.

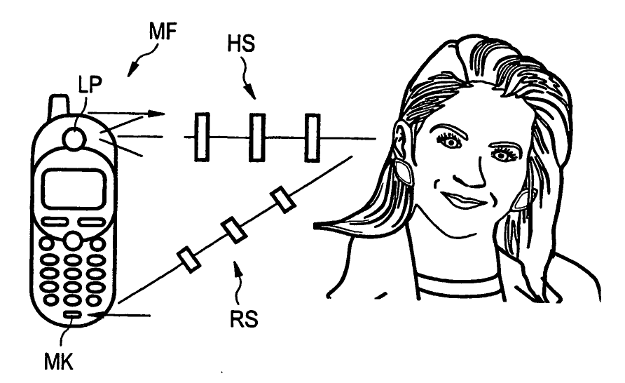

### BACKGROUND

The present disclosure relates to a mobile radio device employing call signal volume control and hands-free functionality.

The mobile radio device can be a cordless telephone in accordance with the DECT standard, for example, or a mobile telephone for a cellular network, in accordance with the GSM standard, as another example.

For reasons of cost and space, future mobile radio devices employing hands-free function and/or call signaling will implement the built-in earphone or the available loudspeaker of the device. When such mobile telephones are operated incorrectly or malfunction, very high volume levels can occur at the ear or user. This can lead to impairment of the user's hearing and potentially to subsequent claims on the manufacturer for compensation. Attempts to lessen the occurrence of high volume levels that use proximity switches and optical devices to measure distance are not always reliable and are also expensive.

### SUMMARY

In an embodiment of the invention, a mobile radio device comprising: a microphone; a speaker, the speaker configured to provide sound reproduction for at least one of hands-free function and call signaling; a unit configured to acoustically measure distance between the speaker and an obstacle by issuing a sound signal from the speaker, detecting a reflected sound signal resulting from the sound signal reflected off the obstacle, and measuring a characteristic of at least one of the sound signal and the reflected sound signal.

Using a mobile radio device employing the disclosed apparatus does not pose any risk of impairment to the user's hearing, particularly in the case of call signaling and the hands-free function.

The analysis of the acoustic coupling between loudspeaker and microphone in the disclosed examples enables the volume of the sound reproduction to be controlled very cost-effectively, particularly in the case of call signaling or hands-free operation.

### BRIEF DESCRIPTION OF THE DRAWINGS

The single FIGURE illustrates a mobile radio device constructed in accordance with the disclosed teachings having a loudspeaker, or an earphone, and a microphone.

### DETAILED DESCRIPTION OF THE PRESENT EXAMPLES

The presently disclosed apparatus serves to protect a user of a mobile radio device MF by rotating acoustically measuring the distance or registering obstacles such as a human head.

In an example, as shown in the FIGURE, the distance between the mobile radio device MF and the ear or head of a user is measured.

In a further example, as can also be seen from the FIGURE, the increasing sound pressure of the higher-frequency sound pulse emitted by the loudspeaker LP between the mobile radio device MF and the ear or ultimately the head of a user is registered.

In a preferred embodiment of the invention, higher-frequency sound signals HS are reproduced by the loudspeaker LP and are reflected off an obstacle, such as the user, and recorded as a reflected signal RS by the microphone MK. These sound pulses have a frequency of 10 kHz or higher, for example. Preferably, the higher-frequency sound signals HS or sound pulses are at a frequency above the frequency range of the voice and the ringtone.

The sound propagation time is determined using the echo recorded by the microphone MK. For example, if the echo (i.e., the reflected signal RS) is received after a sound propagation time of 1 ms, this sound propagation time corresponds to a distance of approximately 0.3 m.

At decreasing distance between the mobile radio device MF and an obstacle, the sound propagation time becomes smaller. For example, at a defined threshold value of the sound propagation time, the hands-free function and/or call signaling is switched off or at least the reproduced signal volume is reduced. A distance of 0.30 m can be set as the threshold value, as an example.

In another alternative, the acoustic coupling between the loudspeaker LP and the microphone MK is determined using the reflection signal RS recorded by the microphone MK. The reflected signal RS is received at a sound pressure that is essentially dependent on the acoustic coupling. At decreasing distance between the mobile radio device MF and an obstacle the acoustic coupling increases because of the increasing sound pressure. The resultant increase in level at the microphone MK is analyzed using a downstream amplifier circuit with high-pass function and comparators for example in the case of a defined threshold value of the sound pressure the hands-free function and/or call signaling is switched off or at least the reproduced signal volume is reduced. A distance of, 0.20 m can be set as a threshold value, for example. Thus, for example, when the head moves closer to the loudspeaker LP the volume of the sound reproduction in hands-free operation or in the case of call signaling is reduced. As the distance increases the volume can be increased again.

It should be understood that various changes and modifications to the presently disclosed examples described herein will be apparent to those skilled in the art. Such changes and modifications can be made without departing from the spirit and scope of the teachings of the present invention and without diminishing its intended advantages. It is therefore intended that such changes and modifications be covered by the appended claims.

1. Mobile radio device (MF) with a microphone (MK) and a loudspeaker (LP), the loudspeaker (LP) being used for sound reproduction for the hands-free function and/or for call signaling, characterized by means for acoustically measuring the distance between the loudspeaker (LP) and an obstacle.

2. Mobile radio device (MF) according to claim 1, in which the means for reproducing higher-frequency sound signals (HS) compared to a voice signal are formed via the loudspeaker (LP), for recording a reflected signal (RS) via the microphone (MK), and for measuring the sound propagation time.

3. Mobile radio device (MF) according to claim 1, in which the means for reproducing higher-frequency sound signals (HS) compared to a voice signal are formed via the loudspeaker (LP), for recording a reflected signal (RS) via the microphone (MK), and for analyzing the acoustic coupling between loudspeaker (LP) and microphone (MK).

4. Mobile radio device (MF) according to claim 2 or 3, in which at a defined value of the sound propagation time or of the coupling the volume of the sound reproduction in particular [for the] hands-free function can be changed.
